(19) United States
(12) Patent Application Publication
(10) Pub. No.: US 2016/0160829 A1
(43) Pub. Date: Jun. 9, 2016

(54) METHOD FOR PREVENTING ENGINE STALL OF VEHICLE

(71) Applicant: HYUNDAI MOTOR COMPANY, Seoul (KR)

(72) Inventor: Channy PARK, Dalseo-gu (KR)

(21) Appl. No.: 14/746,825

(22) Filed: Jun. 22, 2015

(30) Foreign Application Priority Data
Dec. 4, 2014 (KR) 10-2014-0172809

(51) Int. Cl. F02N 11/08; F01N 9/00

(52) U.S. Cl. CPC F02N 11/0825; F01N 9/002; F02N 11/0837; F02N 11/084

(57) ABSTRACT

A method for preventing an engine stall of a vehicle includes a detection step for detecting an idle stop and go (ISG) operation signal or a power take-off (PTO) operation signal; a state determination step for determining whether a PTO currently operates or whether an ISG system currently operates; and an operation limitation step for preventing an engine from stopping by limiting the operation of the ISG system when the ISG operation signal is detected while the PTO currently operates.

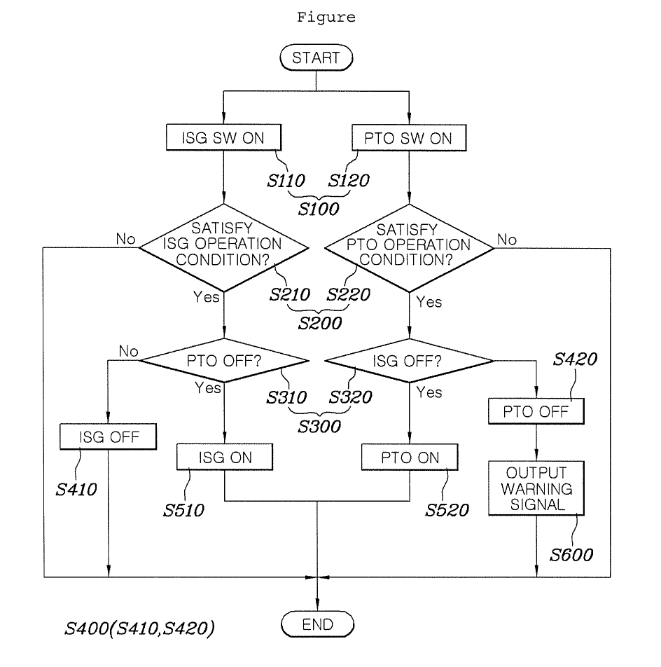

### CROSS REFERENCE TO RELATED APPLICATION

The present application claims the benefit of priority to Korean Patent Application Number 10-2014-0172809 filed on Dec. 4, 2014, the entire content of which application is incorporated herein for all purposes by this reference.

### TECHNICAL FIELD

The present disclosure generally relates to a method for preventing an engine stall, and more particularly, to a method for preventing an engine stall caused due to an idle stop and go (ISG) system while a power take-off (PTO) operates.

### BACKGROUND

A vehicle has power take-off (PTO) for taking power from a power source The PTO is a system to perform a desired operation by driving an external device using the power from a vehicle engine. Examples of the PTO include a removal van, a ladder truck, a vehicle with a hydraulic pump, and the like.

On the other hand, idle stop and go (ISG) is a technology for preventing an engine from idling by stopping the engine when a vehicle stops due to a traffic light or emergency parking.

According to a conventional art, when a vehicle is equipped with a PTO and an ISG system and a condition for operating the ISG system is satisfied while the PTO operates, the ISG system operates and turns off the engine regardless of whether the PTO device operates. Accordingly, power from the engine is blocked during the operation of the PTO device and an unexpected safety accident may occur. Therefore, there exists a need to solve the above problem.

The foregoing is intended merely to aid in the understanding of the background of the present disclosure, and is not intended to mean that the present disclosure falls within the purview of the related art that is already known to those skilled in the art.

### SUMMARY

The present disclosure has been made keeping in mind the above problems, and an aspect of the present inventive concept provides a method for preventing an engine stall that may be caused by an ISG system while PTO operates.

According to an exemplary embodiment of the present inventive concept, a method for preventing an engine stall of a vehicle includes: a detection step for detecting an idle stop and go (ISG) operation signal or a power take-off (PTO) signal; a state determination step for determining whether PTO currently operates or whether ISG currently operates; and an operation limitation step for preventing an engine from stopping by limiting the operation of the ISG when the ISG operation signal is detected while the PTO currently operates.

The method may further include a condition determination step for determining whether a condition for operating the ISG is satisfied when the ISG operation signal is detected, and for determining whether a condition for operating the PTO is satisfied when the PTO operation signal is detected.

The condition determination operation may determine that the condition for operating the ISG is satisfied when at least one factor among a coolant temperature, a brake pressure, a state-of-charge of a battery, whether a door is open, an ambient temperature, a DPF regeneration state, and whether a seat belt is fastened satisfies a preset value or a preset state.

The condition determination operation may determine that the condition for operating the PTO is satisfied when at least one factor among whether the engine is currently operating, whether a vehicle speed is less than a preset speed, whether a clutch is engaged, and whether the clutch is engaged for more than a preset time period satisfies a preset state.

When the PTO operation signal is detected while the ISG currently operates, the operation limitation operation may limit the operation of the PTO.

When the operation of the PTO is limited, the operation limitation operation may display a warning light on an instrument cluster or generates a warning alarm sound.

The ISG operation signal and the PTO operation signal may be detected when an ISG operation switch and a PTO operation switch operate, respectively.

According to the method for preventing the engine stall of a vehicle as describe above, a car accident may be prevented by blocking the operation of an ISG system while a PTO device operates, thus improving marketability and safety of the vehicle.

In addition, as safety is improved by limiting an operating condition without an additional apparatus, a cost-saving effect is expected.

### BRIEF DESCRIPTION OF THE DRAWING

The above and other objects, features and other advantages of the present disclosure will be more clearly understood from the following detailed description taken in conjunction with the accompanying drawings.

The FIGURE shows a flow diagram of a method for preventing an engine stall of a vehicle according to an embodiment of the present inventive concept.

### DETAILED DESCRIPTION

Hereinafter, a method for preventing an engine stall of a vehicle according to an embodiment of the present inventive concept will be described referring to the accompanying drawing.

The FIGURE shows a flow diagram of a method for preventing an engine stall of a vehicle according to an embodiment of the present inventive concept. The method includes a detection step S100 for detecting an idle stop and go (ISG) operation signal or a power take-off (PTO) operation signal; a state determination step S300 for determining whether PTO currently operates or whether ISG currently operates; and an operation limitation step S400 for preventing an engine from stopping by limiting the operation of the ISG at step S410 when the operation signal of the ISG is detected at step S110 while the PTO currently operates.

The PTO, which is a method for taking power from a power source, performs a desired operation by driving an external device using the power from the vehicle engine. The ISG is for preventing an engine from idling by stopping the engine when the vehicle stops due to a traffic light or emergency parking.

When a user presses a PTO operation switch that generates an operation signal of a PTO device, an operation sequence of the PTO device may be performed. Also, when the user presses an ISG operation switch that generates an operation signal of an ISG system, an operation sequence of the ISG system may be performed. When each of the switches is turned on and the operation signal of the switches is detected, the state determination step S300 and the operation limitation step S400 may be performed.

The method for preventing the engine stall may further include a condition determination step S200 for determining whether a predetermined condition for operating the ISG is satisfied at step S210 when the ISG operation switch is turned on and the ISG operation signal is detected at step S110, and determining whether a predetermined condition for operating the PTO is satisfied at step S220 when the PTO operation signal is detected at step S120.

In the present disclosure, the condition determination step S200 precedes the state determination step S300, but logic may be configured as the state determination step S300 is performed prior to the condition determination step S200.

In the condition determination step S200, each condition may be variously set. When at least one factor satisfies a preset value or a preset state among a coolant temperature, a brake pressure, a state-of-charge of a battery, whether a door is open, an ambient temperature, a diesel particulate filter (DPF) regeneration state, whether a seat belt has been fastened, and an air conditioning state of a vehicle, it may be determined that the condition for operating the ISG is satisfied at step S210. When at least one factor satisfies a preset state among whether an engine is operating, whether the vehicle speed is less than the preset speed, whether a clutch is operated, and whether the clutch has been operating longer than a preset time period, it may be determined that the condition for operating the PTO is satisfied at step S220.

More specifically, more state values for each of the factors may be detected at the detection step S100, and when the detected state values satisfy reference values, it may be determined that each of the operation conditions is satisfied.

For example, it may be determined that the condition for operating the ISG is satisfied when the coolant temperature is higher than a reference coolant temperature, the brake pressure is higher than a reference brake pressure, the state-of-charge of the battery is higher than a reference state-of-charge of the battery, the ambient temperature is higher than a reference ambient temperature, the door is closed, the DPF generation is completed, and the seat belt is fastened. It may be determined that the condition for operating the PTO is satisfied when the engine is operating, the vehicle speed is less than the preset speed, the clutch is operated, and the clutch has been operating longer than the preset time period.

In addition to the above descriptions, factors included in each of the operation conditions may be variously set. The operation conditions are satisfied only when all of the above mentioned factors satisfy their reference states or values, but it may be determined that the operation conditions are satisfied when some of the factors satisfy their reference states or values. The reference values or reference states for each of the factors are not limited to the above mentioned conditions, but various reference values or various reference ranges may be set according to a designer's intention or a condition of a vehicle.

Referring to the FIGURE, when the ISG operation signal is detected at step S110, it is determined whether the condition for operating the ISG is satisfied at step S210. When it is determined that the condition for operating the ISG is satisfied, it is determined whether the PTO is on at step S310. When the PTO currently operates, the ISG is controlled not to be operated at step S410, whereby the ISG is off even if the ISG operation switch is turned on. It is possible to change a state of the ISG operation switch to “off” or to display a warning light on an instrument cluster or to sound a warning alarm so that a user presses the ISG operation switch to change the state of the switch to “off.” When the PTO is off, the ISG may operate (S510).

On the other hand, when the PTO operation signal is detected at step S120, it is determined whether the condition for operating the PTO is satisfied at step S220. When it is determined that the condition for operating the PTO is satisfied, it is determined whether the ISG currently operates at step S320. When the ISG currently operates, the PTO is controlled to be off at step S420, whereby it is desirable that the PTO is not operated even if the PTO operation switch is turned on. Further, it is possible to change a state of the PTO operation switch to “off”, or it is possible to display a warning light on an instrument cluster or to sound a warning alarm so that a user presses the PTO operation switch to change the state of the switch to “off” (S600).

When the ISG is off, the PTO may be on (S520). As described above, as either the PTO or the ISG is selectively on, the operation of the ISG may be prevented while PTO operates.

According to the method for preventing the engine stall of a vehicle as describe above, a vehicle accident may be prevented by blocking the operation of an ISG system while a PTO device operates, thus improving marketability and safety of the vehicle.

In addition, without an additional apparatus, as safety is improved by limiting an operating condition, a cost-saving effect is expected.

Although the exemplary embodiment of the present inventive concept has been disclosed for illustrative purposes, those skilled in the art will appreciate that various modifications, additions, and substitutions are possible, without departing from the scope and spirit of the disclosure as disclosed in the accompanying claims.

What is claimed is:

1. A method for preventing an engine stall of a vehicle, comprising:
a detection step for detecting an idle stop and so (ISG) operation signal or a power take-off (PTO) signal;
a state determination step for determining whether PTO currently operates or whether ISG currently operates; and
an operation limitation step for preventing an engine from stopping by limiting the operation of the ISG when the ISG operation signal is detected while the PTO currently operates.

2. The method of claim 1, further comprising,
a condition determination step for determining whether a condition for operating the ISG is satisfied when the ISG operation signal is detected, and for determining whether a condition for operating the PTO is satisfied when the PTO operation signal is detected.

3. The method of claim 2, wherein the condition determination step determines that the condition for operating the ISG is satisfied when at least one factor among a coolant temperature, a brake pressure, a state-of-charge of a battery, whether a door is open, an ambient temperature, a diesel particulate filter (DPF) regeneration state, and whether a seat belt is fastened satisfies a preset value or a preset state.

4. The method of claim 2, wherein the condition determination step determines that the condition for operating the PTO is satisfied when at least one factor among whether the engine currently runs, whether a vehicle speed is less than a preset speed, whether a clutch is engaged, and whether the clutch is engaged for more than a preset time period satisfies a preset state.

5. The method of claim 1, wherein when the PTO operation signal is detected while the ISG currently operates, the operation limitation step limits the operation of the PTO.

6. The method of claim 5, wherein when the operation of the PTO is limited, the operation limitation step displays a warning light on an instrument cluster or generates a warning alarm sound.

7. The method of claim 1, wherein the ISG operation signal and the PTO operation signal are detected when an ISG operation switch and a PTO operation switch operate, respectively.

8. The method of claim 5, wherein when the operation of the PTO is limited, the operation limitation step changes a state of the PTO operation switch to off.

9. The method of claim 8, wherein when the PTO is off, the ISG operates.

10. The method of claim 8, wherein when the ISG is off, the PTO operates.
